(19) United States
(12) Patent Application Publication
(10) Pub. No.: US 2012/0058222 A1
(43) Pub. Date: Mar. 8, 2012

(54) Use

(75) Inventors: Bo Spange Sorensen, Skanderborg (DK); Inge Lise Povlsen, Skanderborg (DK); Rie Mejldal, Ostbirk (DK); Karsten Matthias Kragh, Viby (DK); Anja Hemmingsen Kellett-Smith, Arhus (DK); Rene Mikkelsen, Skanderborg (DK); Rikke L. Bundgaard Jenner, Sabro (DK)

(73) Assignee: Danisco A/S, Copenhagen (DK)

(21) Appl. No.: 13/319,426

(22) PCT Filed: May 19, 2010
(86) PCT No.: PCT/IB2010/052228

§ 371 Date: Nov. 8, 2011

Related U.S. Application Data
(60) Provisional application No. 61/179,525, filed on May 19, 2009.

(30) Foreign Application Priority Data
May 19, 2009 (EP) 09160655.8
Nov. 13, 2009 (GB) 0919888.8
Feb. 2, 2010 (GB) 1001670.7

(51) Int. Cl. A21D 8/04; A21D 13/00; A21D 10/00

(52) U.S. Cl. 426/28; 426/549

(57) ABSTRACT

The present invention relates to the use of an amylase and a lipolytic enzyme in combination to improve the stackability of bread, methods of preparing dough and baked products having a combination of such enzymes, as well as bread having particular bread stackability profiles.

### FIELD OF THE PRESENT INVENTION

The present invention relates to the use of an amylase and a lipolytic enzyme to increase the stackability of bread, methods of preparing dough comprising such enzymes, baked products—such as bread—comprising such enzymes and bread having particular bread stackability profiles.

### BACKGROUND OF THE PRESENT INVENTION

It is desirable for baked products (for example bread) to have an initial firmness after baking which allows the baked products to be stacked without detrimentally affecting the quality and/or appearance of the baked product. However, such initial firmness needs to be balanced with the need for baked products to maintain their freshness over time—e.g. with the need to prevent the staling of baked products.

Accordingly there is a need for a baked product which has a good balance between the initial firmness and the level of increase in firmness over time thereafter. This is referred to herein as “bread stackability”.

### SUMMARY ASPECTS OF THE PRESENT INVENTION

Aspects of the present invention are presented in the claims and in the following commentary.

One aspect of the present invention relates to the use of an amylase and a lipolytic enzyme for improving the stackability of bread.

In a second aspect of the present invention, there is disclosed a method of preparing a dough comprising:
a) adding an amylase as set forth in SEQ ID No. 1 or a non-maltogenic amylase having at least 75% identity to SEQ ID No. 1 in an amount of up to 10 ppm dough; and
b) adding a lipolytic enzyme in an amount of up to 10 ppm dough.

In a third aspect, the present invention relates to a dough comprising:
a) an amylase as set forth in SEQ ID No. 1 or a non-maltogenic amylase having at least 75% identity to SEQ ID No. 1; and
b) a lipolytic enzyme,

wherein the amount of amylase and lipolytic enzyme are each up to 10 ppm dough.

In a fourth aspect, the present invention relates to a baked product prepared by baking a dough comprising:
a) an amylase as set forth in SEQ ID No. 1 or a non-maltogenic amylase having at least 75% identity to SEQ ID No. 1; and
b) a lipolytic enzyme,

wherein the amount of amylase and lipolytic enzyme are each up to 10 ppm dough.

In a fifth aspect, the present invention relates to a bread having:
a) an initial firmness of at least 7 HPa/g;
b) a change in firmness from 2 hours post baking of:
   i. less than or equal to 12 g after 4 days; and/or
   ii. less than or equal to 15 g after 6 days; and/or
   iii. less than or equal to 20 g after 11 days.

In a sixth aspect, the present invention relates to a bread having:
a) an initial firmness of at least 7 HPa/g;
b) a change in firmness from 2 hours post baking of:
   i. less than or equal 1.7 times the initial firmness after 4 days; and/or
   ii. less than or equal to 2.1 times the initial firmness after 6 days; and/or
   iii. less than or equal to 2.9 times the initial firmness after 11 days.

Methods, uses, dough and baked products (such as bread) as substantially described with reference to the Examples are also encompassed by the present invention.

It has surprisingly been found that the use of an amylase and a lipolytic enzyme in combination can provide a good bread stackability.

In particular, it has been found that the use of an amylase and a lipolytic enzyme in combination can provide a good balance between initial firmness two hours post baking and the level of increase in firmness thereafter.

### DETAILED ASPECTS OF THE PRESENT INVENTION

According to a first aspect of the present invention there is provided a use of an amylase and a lipolytic enzyme for improving the stackability of bread.

By “improving the stackability of bread” it is meant that there is an increase in initial firmness after baking and a decrease in firmness over time thereafter compared to a control bread having no amylase and/or lipolytic enzyme added.

By “initial firmness” it is meant the firmness at two hours after baking.

The level of initial firmness which is desirable is dependent on the type of baked good. For example, it may be more desirable to have rye bread with a higher initial firmness than white bread.

Suitably, the initial firmness of the baked product may be higher than that of a control bread where no lipolytic enzyme and amylase is added. For example, suitably the initial firmness may be increased by at least 0.5 HPa/g, preferably at least 1 HPa/g, preferably at least 1.5 HPa/g compared to that of the control.

Suitably, the initial firmness of the baked product may be at least 7 HPa/g.

By “decrease in firmness over time” it is meant that the relative increase in firmness from two hours post baking to at least 4 days—such as 6 days or 11 days—post baking is less than that of a control bread where no lipolytic enzyme and/or amylase is added.

For example, suitably the increase in firmness from two hour post baking to 4 days (or 6 days or 11 days) post baking may be at least 0.5 HPa/g, or at least 1 HPa/g, or at least 1.5 HPa/g, or at least 2.0 HPa/g, or at least 2.5 HPa/g, or at least 3.0 HPa/g, or at least 3.5 HPa/g, or at least 4.0 HPa/g, or at least 4.5 HPa/g, or at least 5.0 HPa/g, or at least 5.5 HPa/g less that the increase in firmness in the control.

Suitably, the change in firmness from 2 hours post baking may be:
i. less than or equal to 12 HPa/g after 4 days; and/or
ii. less than or equal to 15 HPa/g after 6 days; and/or
iii. less than or equal to 20 HPa/g after 11 days.

In one embodiment, the baked product of the present invention may have:
a) an initial firmness of at least 7 HPa/g; and
b) a change in firmness from 2 hours post baking of:
   i. less than or equal 1.7 times the initial firmness after 4 days; and/or
   ii. less than or equal to 2.1 times the initial firmness after 6 days; and/or
   iii. less than or equal to 2.9 times the initial firmness after 11 days.

Suitably, the amylase may be a maltogenic or a non-maltogenic amylase, preferably the amylase may be a non-maltogenic amylase, such as a polypeptide having non-maltogenic exoamylase activity, suitably a non-maltogenic amylase equivalent to the amylase having the sequence set out in SEQ ID 1.

Examples of maltogenic and non-maltogenic amylases are well known to a person of ordinary skill in the art.

Examples of such enzymes are enzymes having a glucan 1,4alpha-maltotetrahydrolase (EC 3.2.1.60) activity for example, GRINDAMYL POWERFresh™ enzymes and enzymes as disclosed in WO05/003339. A suitable non-maltogenic amylase is commercially available as Powersoft™ (available from Danisco NS, Denmark). Maltogenic amylases such as Novamyl™ (Novozymes A/S, Denmark) may also be used.

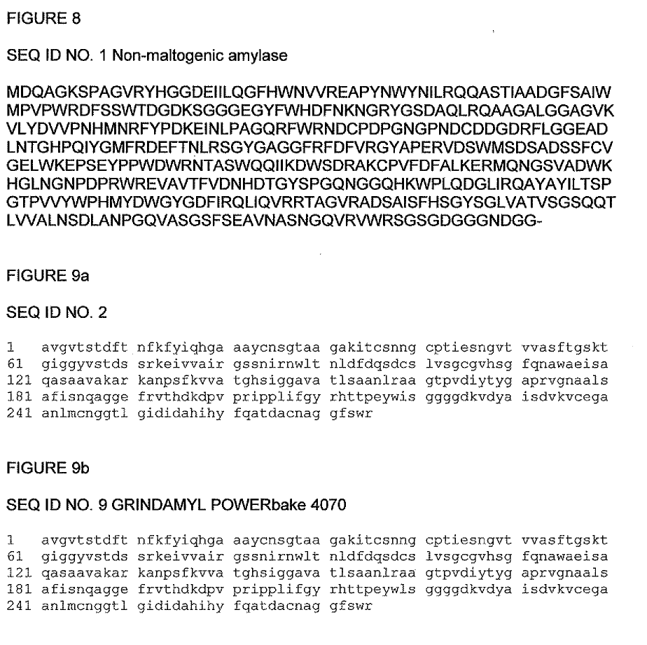

Suitably, the amylase may comprise:
a) an amino acid sequence as set forth in SEQ ID No. 1 (see FIG. 8); or
b) an amino acid sequence having at least 75% identity to SEQ ID No. 1 and encoding a non-maltogenic amylase.

Suitably, a non-maltogenic amylase may comprise an amino acid sequence having at least 80%, or at least 85% or at least 90% or at least 95% or at least 97% identity to SEQ ID No. 1.

The lipolytic enzyme for use in the present invention may have one or more of the following activities selected from the group consisting of: phospholipase activity (such as phospholipase A1 activity (E.C. 3.1.1.32) or phospholipase A2 activity (E.C. 3.1.1.4); glycolipase activity (E.G. 3.1.1.26), triacylglycerol hydrolysing activity (E.C. 3.1.1.3), lipid acyltransferase activity (generally classified as E.C. 2.3.1.x in accordance with the Enzyme Nomenclature Recommendations (1992) of the Nomenclature Committee of the International Union of Biochemistry and Molecular Biology), and any combination thereof. Such lipolytic enzymes are well known within the art.

Suitably, the lipolytic enzyme may be any commercially available lipolytic enzyme. For instance, the lipolytic enzyme may be any one or more of: Lecitase Ultra™, Novozymes, Denmark; Lecitase 10™; a phospholipase A1 from Fusarium spp Lipopan F™, Lipopan Extra™, YieldMax™; a phospholipase A2 from Aspergillus niger, a phospholiapse A2 from Streptomyces violaceruber e.g. LysoMax PLA2™; a phospholipase A2 from Tuber borchii; or a phospholipase B from Aspergillus niger, Lipase 3 (SEQ ID NO. 3), Grindamyl EXEL 16™, and GRINDAMYL POWERBake 4000 range Panamore™, GRINDAMYL POWERBake 4070 (SEQ ID NO 9) or GRINDAMYL POWERBake 4100.

Suitably the lipolytic enzyme for use in the present invention may have one of the following amino acid sequences:
a) an amino acid sequence as set forth in SEQ ID No. 2, or preferably SEQ ID No. 9;
b) an amino acid sequence as set forth in SEQ ID no. 3;
c) an amino acid sequence as set forth in SEQ ID No. 4;
d) an amino acid sequence as set forth in SEQ ID No. 5; or
e) or an amino acid sequence encoding a lipolytic enzyme having at least 70% identity to any of the sequences in a) to d).

An additional enzyme may also present, such as a xylanase and/or an antistaling amylase.

In a second aspect of the present invention, there is disclosed a method of preparing a dough comprising:
a) adding an amylase as set forth in SEQ ID No. 1 or a non-maltogenic amylase having at least 75% identity to SEQ ID No. 1 in an amount of up to 10 ppm dough; and
b) adding a lipolytic enzyme in an amount of up to 10 ppm dough.

Advantageously, such dosages of these two enzymes can result in desirable bread stackability profile for a baked product.

Suitably, the amount of lipolytic enzyme used may be 0.1 to 9 ppm dough, 0.1 to 8 ppm dough, 0.1 to 7 ppm dough, 0.1 to 6 ppm dough, 0.1 to 5 ppm dough, 0.2 to 5 ppm dough, 0.2 to 4 ppm dough, 0.2 to 3 ppm dough, preferably 0.2 to 2 ppm dough, or 0.3 to 1 ppm dough and/or the amount of amylase used may be 0.1 to 9 ppm dough, 0.1 to 8 ppm dough, 0.1 to 7 ppm dough, 0.1 to 6 ppm dough, 0.1 to 5 ppm dough, 0.2 to 5 ppm dough, 0.2 to 4 ppm dough, 0.2 to 3 ppm dough, preferably 0.2 to 2 ppm dough, or 0.3 to 1 ppm dough.

Suitably, a lipolytic enzyme for use with the present invention may be identified using one or more of the following assays.

Determination of Phospholipase Activity (TIPU-K Assay):

Substrate:

0.6% L-α Phosphatidylcholine 95% Plant (Avanti #441601), 0.4% Triton-X 100 (Sigma X-100), and 5 mM CaCl₂ were dissolved in 0.05M HEPES buffer pH 7.

Assay Procedure:

34 μl substrate was added to a cuvette, using a KoneLab automatic analyzer. At time 0 min, 4 μl enzyme solution was added. Also a blank with water instead of enzyme was analyzed. The sample was mixed and incubated at 30° C. for 10 minutes. The free fatty acid content of sample was analyzed by using the NEFA C kit from WAKO GmbH.

Enzyme activity TIPU pH 7 was calculated as micromole fatty acid produced per minute under assay conditions.

Protocol for the Determination of % Acyltransferase Activity:

An edible oil to which a lipid acyltransferase according to the present invention has been added may be extracted following the enzymatic reaction with CHCl3:CH3OH 2:1 and the organic phase containing the lipid material is isolated and analysed by GLC and HPLC according to the procedure detailed hereinbelow. From the GLC and HPLC analyses the amount of free fatty acids and one or more of sterol/stanol esters; are determined. A control edible oil to which no enzyme according to the present invention has been added, is analysed in the same way.

Calculation:

From the results of the GLC and HPLC analyses the increase in free fatty acids and sterol/stanol esters can be calculated:

Δ % fatty acid=% Fatty acid(enzyme)−% fatty acid (control); Mv fatty acid=average molecular weight of the fatty acids;

A=Δ % sterol ester/Mv sterol ester (where Δ % sterol ester=% sterol/stanol ester(enzyme)−% sterol/stanol ester(control) and Mv sterol ester=average molecular weight of the sterol/stanol esters);

The transferase activity is calculated as a percentage of the total enzymatic activity:

$$\% transferase activity = \frac{A \times 100}{A + Δ \% fatty acid \text{/} ( Mv fatty acid )}$$

If the free fatty acids are increased in the edible oil they are preferably not increased substantially, i.e. to a significant degree. By this we mean, that the increase in free fatty acid does not adversely affect the quality of the edible oil.

The edible oil used for the acyltransferase activity assay is preferably the soya bean oil supplemented with plant sterol (1%) and phosphatidylcholine (2%) oil using the method:
Plant sterol and phosphatidylcholine were dissolved in soya bean oil by heating to 95° C. during agitation.
The oil was then cooled to 40° C. and the enzymes were added.
The sample was maintained at 40° C. with magnetic stirring and samples were taken out after 4 and 20 hours and analysed by TLC.

For the assay the enzyme dosage used is preferably 0.2 TIPU-K/g oil, more preferably 0.08 TIPU-K/g oil, preferably 0.01 TIPU-K/g oil. The level of phospholipid present in the oil and/or the % conversion of sterol is preferably determined after 4 hours, more preferably after 20 hours.

When the enzyme used is a lipid acyltransferase enzyme preferably the incubation time is effective to ensure that there is at least 5% transferase activity, preferably at least 10% transferase activity, preferably at least 15%, 20%, 25% 26%, 28%, 30%, 40% 50%, 60% or 75% transferase activity.

The % transferase activity (i.e. the transferase activity as a percentage of the total enzymatic activity) may be determined by the protocol taught above.

In addition to, or instead of, assessing the % transferase activity in an oil (above), to identify the lipid acyl transferase enzymes most preferable for use in the methods of the invention the following assay entitled “Protocol for identifying lipid acyltransferases for use in the present invention” can be employed.

Protocol for Identifying Lipid Acyltransferases

A lipid acyltransferase in accordance with the present invention is one which results in:
i) the removal of phospholipid present in a soya bean oil supplemented with plant sterol (1%) and phosphatidylcholine (2%) oil (using the method: Plant sterol and phosphatidylcholine were dissolved in soya bean oil by heating to 95° C. during agitation. The oil was then cooled to 40° C. and the enzymes were added. The sample was maintained at 40° C. with magnetic stirring and samples were taken out after 4 and 20 hours and analysed by TLC); and/or
ii) the conversion (% conversion) of the added sterol to sterol-ester (using the method taught in i) above). The GLC method for determining the level of sterol and sterol esters as taught in Example 2 may be used.

For the assay the enzyme dosage used may be 0.2 TIPU-K/g oil, preferably 0.08 TIPU-K/g oil, preferably 0.1 TIPU-K/g oil. The level of phospholipid present in the oil and/or the conversion (% conversion) of sterol is preferably determined after 4 hours, more preferably after 20 hours.

In the protocol for identifying lipid acyl transferases, after enzymatic treatment, 5% water is preferably added and thoroughly mixed with the oil. The oil is then separated into an oil and water phase using centrifugation (see “Enzyme-catalyzed degumming of vegetable oils” by Buchold, H. and Laurgi A.-G., Fett Wissenschaft Technologie (1993), 95(8), 300-4, ISSN: 0931-5985), and the oil phase can then be analysed for phosphorus content using the following protocol (“Assay for Phosphorus Content”):

Amylase

The term “amylase” is used in its normal sense—e.g. an enzyme that is inter alia capable of catalysing the degradation of starch. In particular they are hydrolases which are capable of cleaving α-D-(1,4)-glycosidic linkages in starch.

Amylases are starch-degrading enzymes, classified as hydrolases, which cleave α-D-(1,4) -glycosidic linkages in starch. Generally, α-amylases (E.C. 3.2.1.1, α-D-(1,4)-glucan glucanohydrolase) are defined as endo-acting enzymes cleaving α-D-(1,4)-glycosidic linkages within the starch molecule in a random fashion. In contrast, the exo-acting amylolytic enzymes, such as β-amylases (E.C. 3.2.1.2, α-D-(1,4)-glucan maltohydrolase), and some product-specific amylases like maltogenic alpha-amylase (E.C.3.2.1.133) cleave the starch molecule from the non-reducing end of the substrate. β-amylases, α-glucosidases (E.C. 3.2.1.20, α-D-glucoside glucohydrolase), glucoamylase (E.C. 3.2.1.3, α-D-(144)-glucan glucohydrolase), and product-specific amylases can produce malto-oligosaccharides of a specific length from starch.

Suitably, the amylase for use in the present invention may be a non-maltogenic amylase, such as a non-maltogenic exoamylase.

In one embodiment, the term “non-maltogenic exoamylase enzyme” as used in this document should be taken to mean that the enzyme does not initially degrade starch to substantial amounts of maltose as analysed in accordance with the product determination procedure as described in this document.

Suitably, the non-maltogenic exoamylase may comprise an exo-maltotetraohydrolase. Exo-maltotetraohydrolase (E.C.3.2.1.60) is more formally known as glucan 1,4-alpha-maltotetrahydrolase. This enzyme hydrolyses 1,4-alpha-D-glucosidic linkages in amylaceous polysaccharides so as to remove successive maltotetraose residues from the non-reducing chain ends.

Non-maltogenic exoamylases are described in detail in U.S. Pat. No. 6,667,065, hereby incorporated by reference.

In one embodiment the amylase used in the present invention may be a polypeptide having amylase activity as described in EP 09160655.8 (the contents of which are incorporated herein by reference). For ease of reference, some of those amylases are now described in the following numbered paragraphs. Any of the enzymes described in the following numbered paragraphs may be used at a dosage of 10 ppm or less in the dough.

1. A polypeptide having amylase activity comprising an amino acid sequence having
a. at least 78% sequence identity to the amino acid sequence of SEQ ID NO: 7, and wherein the polypeptide comprises one or more amino acid substitutions at the following positions: 235, 16, 48, 97, 105, 240, 248, 266, 311, 347, 350, 362, 364, 369, 393, 395, 396, 400, 401, 403, 412 or 409 and/or
b. at least 65% sequence identity to the amino acid sequence of SEQ ID NO: 7, and wherein the polypeptide comprises one or more amino acid substitutions at the following positions: 88 or 205, and/or
c. at least 78% sequence identity to the amino acid sequence of SEQ ID NO: 7, and wherein the polypeptide comprises one or more of the following amino acid substitutions: 42K/A/V/N/I/H/F, 34Q, 100Q/K/N/R, 272D, 392 KID/E/Y/N/Q/R/T/G or 399C/H and/or
d. at least 95% sequence identity to the amino acid sequence of SEQ ID NO: 7, and wherein the polypeptide comprises one or more amino acid substitutions at the following positions: 44, 96, 204, 354 or 377 and/or
e. at least 95% sequence identity to the amino acid sequence of SEQ ID NO: 7, and wherein the polypeptide comprises the following amino acid substitution: 392S
with reference to the position numbering of the sequence shown as SEQ ID NO: 7.

2. The polypeptide according to paragraph 1 above, wherein the polypeptide comprises one or more amino acid substitutions at the following positions: 235, 88, 205, 240, 248, 266, 311, 377 or 409 and/or one or more of the following amino acid substitutions: 42K/A/V/N/I/H/F, 34Q, 100Q/K/N/R, 272D or 392K/D/E/Y/N/Q/R/S/T/G.

3. The polypeptide according to any one of paragraphs 1 or 2 above, wherein the polypeptide comprises one or more amino acid substitutions at the following positions: 235, 88, 205, 240, 311 or 409 and/or one or more of the following amino acid substitutions: 42K/N/I/H/F, 272D, or 392 K/D/E/Y/N/Q/R/S/T/G.

4. The polypeptide according to any one of paragraphs 1 to 3 above, wherein the polypeptide comprises amino acid substitutions at least in four, five or in all of the following positions: 88, 205, 235, 240, 311 or 409 and/or has at least one, or two the following amino acid substitutions: 42K/N/I/H/F, 272D or 392 K/D/E/Y/N/Q/R/S/T/G.

5. The polypeptide according to any one of paragraphs 1 to 4 above, wherein the polypeptide further comprises one or more of the following amino acids 33Y, 34N, 70D, 121F, 134R, 141P, 146G, 157L, 161A, 178F, 179T, 223E/S/K/A, 229P, 307K, 309P and 334P.

6. The polypeptide according to any one of paragraphs 1 to 5 above having at least 90, 91, 92, 93, 94, 95, 96, 97, 98, or 99% sequence identity to the amino acid sequence of SEQ ID NO: 7.

7. The polypeptide according to any one of paragraphs 1 to 6 above, wherein the polypeptide comprises an amino acid substitution in position 88.

8. The polypeptide according to paragraph 7 above, wherein the polypeptide has the amino acid 88L.

9. The polypeptide according to any one of paragraphs 1 to 8 above, wherein the polypeptide comprises an amino acid substitution in position 235.

10. The polypeptide according to paragraph 9 above, wherein the polypeptide has the amino acid 235R.

11. polypeptide according to any one of paragraphs 1 to 10 above, wherein the polypeptide further comprises one or more of the following amino acids 121 F, 134R, 141 P, 229P, or 307K.

12. The polypeptide according to any one of paragraphs 1 to 11 above having a linker fused at the C-terminus.

13. The polypeptide according to any one of paragraphs 1 to 12 above having exoamylase activity.

14. The polypeptide according to any one of paragraphs 1 to 13 above having non-maltogenic exoamylase activity.

Assays for Non-Maltogenic Exoamylase Activity

The following system is used to characterize polypeptides having non-maltogenic exoamylase activity which are suitable for use in accordance with the present invention.

By way of initial background information, waxy maize amylopectin (obtainable as WAXILYS 200 from Roquette, France) is a starch with a very high amylopectin content (above 90%).

20 mg/ml of waxy maize starch is boiled for 3 min. in a buffer of 50 mM MES (2-(N-morpholino)ethanesulfonic acid), 2 mM calcium chloride, pH 6.0 and subsequently incubated at 50° C. and used within half an hour.

One unit of the non-maltogenic exoamylase is defined as the amount of enzyme which releases hydrolysis products equivalent to I μmol of reducing sugar per min. when incubated at 50 degrees C. in a test tube with 4 ml of 10 mg/ml waxy maize starch in 50 mM MES, 2 mM calcium chloride, pH 6.0 prepared as described above.

Reducing sugars are measured using maltose as standard and using a method known in the art for quantifying reducing sugars; in particular the dinitrosalicylic acid method of Bernfeld, Methods Enzymol., (1 954), 1, 149-1 58.

The hydrolysis product pattern of the non-maltogenic exoamylase is determined by incubating 0.7 units of non-maltogenic exoamylase for 15 or 300 min. at 50° C. in a test tube with 4 ml of 10 mg/ml waxy maize starch in the buffer prepared as described above.

The reaction is stopped by immersing the test tube for 3 min. in a boiling water bath.

The hydrolysis products are analyzed and quantified by anion exchange HPLC using a Dionex PA 100 column with sodium acetate, sodium hydroxide and water as eluents, with pulsed amperometric detection and with known linear maltooligosaccharides of from glucose to maltoheptaose as standards. The response factor used for maltooctaose to maltodecaose is the response factor found for maltoheptaose.

Preferably, an enzyme is a non-maltogenic exoamylase and has non-maltogenic exoamylase activity when used in the following method. An amount of 0.7 units of said non-maltogenic exoamylase is incubated for 15 minutes at a temperature of 50° C. and pH 6 in 4 ml of an aqueous solution of 10 mg preboiled waxy maize starch per ml buffered solution containing 50 mM 2-(N-morpholino) ethane sulfonic acid and 2 mM calcium chloride. The enzyme yields hydrolysis product(s) that consist of one or more linear malto-oligosaccharides of from two to ten D-glucopyranosyl units and optionally glucose. At least 60%, preferably at least 70%, more preferably at least 80% and most preferably at least 85% by weight of the said hydrolysis products would consist of linear maltooligosaccharides of from three to ten D-glucopyranosyl units, preferably of linear maltooligosaccharides consisting of from four to eight D-glucopyranosyl units.

For ease of reference, and for the present purposes, the feature of incubating an amount of 0.7 units of the non-maltogenic exoamylase for 15 minutes at a temperature of 50° C. at pH 6.0 in 4 ml of an aqueous solution of 10 mg preboiled waxy maize starch per ml buffered solution containing 50 mM 2-(N-morpholino)ethane sulfonic acid and 2 mM calcium chloride, may be referred to as the “Waxy Maize Starch Incubation Test”.

Thus, alternatively expressed, preferred non-maltogenic amylases of the present invention are characterised as having the ability in the waxy maize starch incubation test to yield hydrolysis products that would consist of one or more linear malto-oligosaccharides of from two to ten D-glucopyranosyl units and optionally glucose; such that at least 60%, preferably at least 70%, more preferably at least 80% and most preferably at least 85% by weight of the said hydrolysis products would consist of linear maltooligosaccharides of from three to ten D-glucopyranosyl units, preferably of linear maltooligosaccharides consisting of from four to eight D-glucopyranosyl units.

The hydrolysis products in the waxy maize starch incubation test may include one or more linear malto-oligosaccharides of from two to ten D-glucopyranosyl units and optionally glucose. The hydrolysis products in the waxy maize starch incubation test may also include other hydrolytic products. Nevertheless, the % weight amounts of linear maltooligosaccharides of from three to ten D-glucopyranosyl units are based on the amount of the hydrolysis product that consists of one or more linear maltooligosaccharides of from two to ten D-glucopyranosyl units and optionally glucose. In other words, the % weight amounts of linear maltooligosaccharides of from three to ten Dglucopyranosyl units are not based on the amount of hydrolysis products other than one or more linear malto-oligosaccharides of from two to ten D-glucopyranosyl units and glucose.

The hydrolysis products can be analysed by any suitable means. For example, the hydrolysis products may be analysed by anion exchange HPLC using a Dionex PA 100 column with pulsed amperometric detection and with, for example, known linear maltooligosaccharides of from glucose to maltoheptaose as standards.

For ease of reference, and for the present purposes, the feature of analysing the hydrolysis product(s) using anion exchange HPLC using a Dionex PA 100 column with pulsed amperometric detection and with known linear maltooligosaccharides of from glucose to maltoheptaose used as standards, can be referred to as “analysing by anion exchanges”. Of course, and as just indicated, other analytical techniques would suffice, as well as other specific anion exchange techniques.

Thus, alternatively expressed, a preferred amylase is one which has non-maltogenic exoamylase activity such that it has the ability in a waxy maize starch incubation test to yield hydrolysis product(s) that would consist of one or more linear maltooligosaccharides of from two to ten D-glucopyranosyl units and optionally glucose, said hydrolysis products being capable of being analysed by anion exchange; such that at least 60%, preferably at least 70%, more preferably at least 80% and most preferably at least 85% by weight of the said hydrolysis product(s) would consist of linear maltooligosaccharides of from three to ten D-glucopyranosyl units, preferably of linear maltooligosaccharides consisting of from four to eight D-glucopyranosyl units.

As used herein, the term “linear malto-oligosaccharide” is used in the normal sense as meaning 2-1 0 units of a-D-glucopyranose linked by an α-(1-4) bond.

Further Enzymes

In addition to the amylase and lipolytic enzyme one or more further enzymes may be used, for example added to the food, dough preparation, or foodstuff.

Further enzymes that may be added to the dough include oxidoreductases, hydrolases, such as lipases and esterases as well as glycosidases like α-amylase, pullulanase, and xylanase. Oxidoreductases, such as for example glucose oxidase and hexose oxidase, can be used for dough strengthening and control of volume of the baked products and xylanases and other hemicellulases may be added to improve dough handling properties, crumb softness and bread volume. Lipases are useful as dough strengtheners and crumb softeners and α-amylases and other amylolytic enzymes may be incorporated into the dough to control bread volume.

Further enzymes that may be used may be selected from the group consisting of a cellulase, a hemicellulase, a starch degrading enzyme, a protease, a lipoxygenase.

Examples of useful oxidoreductases include oxidises such as a glucose oxidase (EC 1.1.3.4), carbohydrate oxidase, glycerol oxidase, pyranose oxidase, galactose oxidase (EC 1.1.3.10), a maltose oxidising enzyme such as hexose oxidase (EC 1.1.3.5).

Other useful starch degrading enzymes which may be added to a dough composition include glucoamylases and pullulanases.

Preferably, the further enzyme is at least a xylanase and/or at least an antistaling amylase.

The term “xylanase” as used herein refers to xylanases (EC 3.2.1.32) which hydrolyse xylosidic linkages.

The term “amylase” as used herein refers to amylases such as α-amylases (EC 3.2.1 .I), β-amylases (EC 3.2.1.2) and γ-amylases (EC 3.2.1.3.).

The further enzyme can be added together with any dough ingredient including the flour, water or optional other ingredients or additives, or a dough improving composition. The further enzyme can be added before the flour, water, and optionally other ingredients and additives or the dough improving composition. The further enzyme can be added after the flour, water, and optionally other ingredients and additives or the dough improving composition. The further enzyme may conveniently be a liquid preparation. However, the composition may be conveniently in the form of a dry composition.

Some enzymes of the dough improving composition are capable of interacting with each other under the dough conditions to an extent where the effect on improvement of the rheological and/or machineability properties of a flour dough and/or the quality of the product made from dough by the enzymes is not only additive, but the effect is synergistic.

In relation to improvement of the product made from dough (finished product), it may be found that the combination results in a substantial synergistic effect in respect to crumb structure. Also, with respect to the specific volume of baked product a synergistic effect may be found.

Host Cell

The host organism can be a prokaryotic or a eukaryotic organism.

In one embodiment of the present invention the lipolytic enzyme according to the present invention in expressed in a host cell, for example a bacterial cells, such as a Bacillus spp, for example a Bacillus licheniformis host cell.

Alternative host cells may be fungi, yeasts or plants for example.

It has been found that the use of a Bacillus licheniformis host cell results in increased expression of a lipid acyltransferase when compared with other organisms, such as Bacillus subtilis.

Isolated

In one aspect, the enzymes for use in the present invention may be in an isolated form.

The term “isolated” means that the sequence or protein is at least substantially free from at least one other component with which the sequence or protein is naturally associated in nature and as found in nature.

Purified

In one aspect, the enzymes for use in the present invention may be used in a purified form.

The term “purified” means that the sequence is in a relatively pure state—e.g. at least about 51% pure, or at least about 75%, or at least about 80%, or at least about 90% pure, or at least about 95% pure or at least about 98% pure.

Cloning a Nucleotide Sequence Encoding a Polypeptide According to the Present Invention

A nucleotide sequence encoding either a polypeptide which has the specific properties as defined herein or a polypeptide which is suitable for modification may be isolated from any cell or organism producing said polypeptide. Various methods are well known within the art for the isolation of nucleotide sequences.

For example, a genomic DNA and/or cDNA library may be constructed using chromosomal DNA or messenger RNA from the organism producing the polypeptide. If the amino acid sequence of the polypeptide is known, labeled oligonucleotide probes may be synthesised and used to identify polypeptide-encoding clones from the genomic library prepared from the organism. Alternatively, a labelled oligonucleotide probe containing sequences homologous to another known polypeptide gene could be used to identify polypeptide-encoding clones. In the latter case, hybridisation and washing conditions of lower stringency are used.

Alternatively, polypeptide-encoding clones could be identified by inserting fragments of genomic DNA into an expression vector, such as a plasmid, transforming enzyme-negative bacteria with the resulting genomic DNA library, and then plating the transformed bacteria onto agar containing an enzyme inhibited by the polypeptide, thereby allowing clones expressing the polypeptide to be identified.

In a yet further alternative, the nucleotide sequence encoding the polypeptide may be prepared synthetically by established standard methods, e.g. the phosphoroamidite method described by Beucage S. L. et al (1981) Tetrahedron Letters 22, p 1859-1869, or the method described by Matthes et al (1984) EMBO J. 3, p 801-805. In the phosphoroamidite method, oligonucleotides are synthesised, e.g. in an automatic DNA synthesiser, purified, annealed, ligated and cloned in appropriate vectors.

The nucleotide sequence may be of mixed genomic and synthetic origin, mixed synthetic and cDNA origin, or mixed genomic and cDNA origin, prepared by ligating fragments of synthetic, genomic or cDNA origin (as appropriate) in accordance with standard techniques. Each ligated fragment corresponds to various parts of the entire nucleotide sequence. The DNA sequence may also be prepared by polymerase chain reaction (PCR) using specific primers, for instance as described in U.S. Pat. No. 4,683,202 or in Saiki R K et al (Science (1988) 239, pp 487-491).

Nucleotide Sequences

The present invention also encompasses nucleotide sequences encoding polypeptides having the specific properties as defined herein. The term “nucleotide sequence” as used herein refers to an oligonucleotide sequence or polynucleotide sequence, and variant, homologues, fragments and derivatives thereof (such as portions thereof). The nucleotide sequence may be of genomic or synthetic or recombinant origin, which may be double-stranded or single-stranded whether representing the sense or antisense strand.

The term “nucleotide sequence” in relation to the present invention includes genomic DNA, cDNA, synthetic DNA, and RNA. Preferably it means DNA, more preferably cDNA for the coding sequence.

In a preferred embodiment, the nucleotide sequence per se encoding a polypeptide having the specific properties as defined herein does not cover the native nucleotide sequence in its natural environment when it is linked to its naturally associated sequence(s) that is/are also in its/their natural environment. For ease of reference, we shall call this preferred embodiment the “non-native nucleotide sequence”. In this regard, the term “native nucleotide sequence” means an entire nucleotide sequence that is in its native environment and when operatively linked to an entire promoter with which it is naturally associated, which promoter is also in its native environment. Thus, the polypeptide of the present invention can be expressed by a nucleotide sequence in its native organism but wherein the nucleotide sequence is not under the control of the promoter with which it is naturally associated within that organism.

Preferably the polypeptide is not a native polypeptide. In this regard, the term “native polypeptide” means an entire polypeptide that is in its native environment and when it has been expressed by its native nucleotide sequence.

Typically, the nucleotide sequence encoding polypeptides having the specific properties as defined herein is prepared using recombinant DNA techniques (i.e. recombinant DNA). However, in an alternative embodiment of the invention, the nucleotide sequence could be synthesised, in whole or in part, using chemical methods well known in the art (see Caruthers M H at al (1980) Nuc Acids Res Symp Ser 215-23 and Horn T et al (1980) Nuc Acids Res Symp Ser 225-232).

Molecular Evolution

Once an enzyme-encoding nucleotide sequence has been isolated, or a putative enzyme-encoding nucleotide sequence has been identified, it may be desirable to modify the selected nucleotide sequence, for example it may be desirable to mutate the sequence in order to prepare an enzyme in accordance with the present invention.

Mutations may be introduced using synthetic oligonucleotides. These oligonucleotides contain nucleotide sequences flanking the desired mutation sites.

A suitable method is disclosed in Morinaga et al (Biotechnology (1984) 2, p646-649). Another method of introducing mutations into enzyme-encoding nucleotide sequences is described in Nelson and Long (Analytical Biochemistry (1989), 180, p 147-151).

Instead of site directed mutagenesis, such as described above, one can introduce mutations randomly for instance using a commercial kit such as the GeneMorph PCR mutagenesis kit from Stratagene, or the Diversify PCR random mutagenesis kit from Clontech. EP 0 583 265 refers to methods of optimising PCR based mutagenesis, which can also be combined with the use of mutagenic DNA analogues such as those described in EP 0 866 796. Error prone PCR technologies are suitable for the production of variants of lipid acyl transferases with preferred characteristics. WO0206457 refers to molecular evolution of lipases.

A third method to obtain novel sequences is to fragment non-identical nucleotide sequences, either by using any number of restriction enzymes or an enzyme such as Dnase I, and reassembling full nucleotide sequences coding for functional proteins. Alternatively one can use one or multiple non-identical nucleotide sequences and introduce mutations during the reassembly of the full nucleotide sequence. DNA shuffling and family shuffling technologies are suitable for the production of variants of lipid acyl transferases with preferred characteristics. Suitable methods for performing ‘shuffling’ can be found in EP0 752 008, EP1 138 763, EP1 103 606. Shuffling can also be combined with other forms of DNA mutagenesis as described in U.S. Pat. No. 6,180,406 and WO 01/34835.

Thus, it is possible to produce numerous site directed or random mutations into a nucleotide sequence, either in vivo or in vitro, and to subsequently screen for improved functionality of the encoded polypeptide by various means. Using in silico and exo mediated recombination methods (see WO 00/58517, U.S. Pat. No. 6,344,328, U.S. Pat. No. 6,361,974), for example, molecular evolution can be performed where the variant produced retains very low homology to known enzymes or proteins. Such variants thereby obtained may have significant structural analogy to known transferase enzymes, but have very low amino acid sequence homology.

As a non-limiting example, In addition, mutations or natural variants of a polynucleotide sequence can be recombined with either the wild type or other mutations or natural variants to produce new variants. Such new variants can also be screened for improved functionality of the encoded polypeptide.

The application of the above-mentioned and similar molecular evolution methods allows the identification and selection of variants of the enzymes of the present invention which have preferred characteristics without any prior knowledge of protein structure or function, and allows the production of non-predictable but beneficial mutations or variants. There are numerous examples of the application of molecular evolution in the art for the optimisation or alteration of enzyme activity, such examples include, but are not limited to one or more of the following: optimised expression and/or activity in a host cell or in vitro, increased enzymatic activity, altered substrate and/or product specificity, increased or decreased enzymatic or structural stability, altered enzymatic activity/specificity in preferred environmental conditions, e.g. temperature, pH, substrate

As will be apparent to a person skilled in the art, using molecular evolution tools an enzyme may be altered to improve the functionality of the enzyme.

Suitably, the nucleotide sequence encoding a lipolytic enzyme and/or amylase used in the invention may encode a variant, i.e. the lipolytic enzyme and/or amylase may contain at least one amino acid substitution, deletion or addition, when compared to a parental enzyme. Variant enzymes retain at least 70%, 80%, 90%, 95%, 97%, 99% homology with the parent enzyme.

Variant lipolytic enzymes may have decreased activity on triglycerides, and/or monoglycerides and/or diglycerides compared with the parent enzyme.

Suitably the variant enzyme may have no activity on triglycerides and/or monoglycerides and/or diglycerides.

Alternatively, the variant enzyme may have increased thermostability.

The variant enzyme may have increased activity on one or more of the following, polar lipids, phospholipids, lecithin, phosphatidylcholine, glycolipids, digalactosyl monoglyceride, monogalactosyl monoglyceride.

Variants of lipid acyltransferases are known, and one or more of such variants may be suitable for use in the methods and uses according to the present invention and/or in the enzyme compositions according to the present invention. By way of example only, variants of lipid acyltransferases are described in the following references may be used in accordance with the present invention: Hilton & Buckley J Biol. Chem. 1991 Jan. 15: 266 (2): 997-1000; Robertson at al J. Biol. Chem. 1994 Jan. 21; 269(3):2146-50; Brumlik at al J. Bacterial 1996 April; 178 (7): 2060-4; Peelman et al Protein Sci. 1998 March; 7(3):587-99.

Amino Acid Sequences

The present invention also encompasses the use of amino acid sequences encoded by a nucleotide sequence which encodes an enzyme for use in any one of the methods and/or uses of the present invention.

As used herein, the term “amino acid sequence” is synonymous with the term “polypeptide” and/or the term “protein”. In some instances, the term “amino acid sequence” is synonymous with the term “peptide”.

The amino acid sequence may be prepared/isolated from a suitable source, or it may be made synthetically or it may be prepared by use of recombinant DNA techniques.

Suitably, the amino acid sequences may be obtained from the isolated polypeptides taught herein by standard techniques.

One suitable method for determining amino acid sequences from isolated polypeptides is as follows:

Purified polypeptide may be freeze-dried and 100 μg of the freeze-dried material may be dissolved in 50 μl of a mixture of 8 M urea and 0.4 M ammonium hydrogen carbonate, pH 8.4. The dissolved protein may be denatured and reduced for 15 minutes at 50° C. following overlay with nitrogen and addition of 5 μl of 45 mM dithiothreitol. After cooling to room temperature, 5 μl of 100 mM iodoacetamide may be added for the cysteine residues to be derivatized for 15 minutes at room temperature in the dark under nitrogen.

135 μl of water and 5 μg of endoproteinase Lys-C in 5 μl of water may be added to the above reaction mixture and the digestion may be carried out at 37° C. under nitrogen for 24 hours.

The resulting peptides may be separated by reverse phase HPLC on a VYDAC C18 column (0.46×15 cm; 10 μm; The Separation Group, California, USA) using solvent A: 0.1% TFA in water and solvent B: 0.1% TFA in acetonitrile. Selected peptides may be re-chromatographed on a Develosil C18 column using the same solvent system, prior to N-terminal sequencing. Sequencing may be done using an Applied Biosystems 476A sequencer using pulsed liquid fast cycles according to the manufacturer's instructions (Applied Biosystems, California, USA).

Sequence Identity or Sequence Homology

Here, the term “homologue” means an entity having a certain homology with the subject amino acid sequences and the subject nucleotide sequences. Here, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 50%, 55%, 60%, 70%, 71%, 72%, 73%, 74%, 75%, 80%, 85%, 90%, 95% or 98% identical, preferably at least 95 or 98% identical to the subject sequence. Typically, the homologues will comprise the same active sites etc. as the subject amino acid sequence. Although homology can also be considered in terms of similarity (i.e. amino acid residues having similar chemical properties/functions), in the context of the present invention it is preferred to express homology in terms of sequence identity.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI (Invitrogen Corp.). Examples of other software that can perform sequence comparisons include, but are not limited to, the BLAST package (see Ausubel et al 1999 Short Protocols in Molecular Biology, 4^{th} Ed—Chapter 18), and FASTA (Altschul at al 1990 J. Mol. Biol. 403-410). Both BLAST and FASTA are available for offline and online searching (see Ausubel at al 1999, pages 7-58 to 7-60). However, for some applications, it is preferred to use the Vector NTI program. A new tool, called BLAST 2 Sequences is also available for comparing protein and nucleotide sequence (see FEMS Microbiol Lett 1999 174(2): 247-50; FEMS Microbiol Lett 1999 177(1): 187-8 and tatiana@ncbi.nlm.nih.gov).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Alternatively, percentage homologies may be calculated using the multiple alignment feature in Vector NTI (Invitrogen Corp.), based on an algorithm, analogous to CLUSTAL (Higgins D G & Sharp P M (1988), Gene 73(1), 237-244).

Once the software has produced an optimal alignment, it is possible to calculate % homology, preferably % sequence identity. The software typically does this as part of the sequence comparison and generates a numerical result.

Should Gap Penalties be used when determining sequence identity, then preferably the following parameters are used for pairwise alignment:

| FOR BLAST | |
|---|---|
| GAP OPEN | 0 |
| GAP EXTENSION | 0 |

| FOR CLUSTAL | DNA | PROTEIN | |
|---|---|---|---|
| WORD SIZE | 2 | 1 | K triple |
| GAP PENALTY | 15 | 10 | |
| GAP EXTENSION | 6.66 | 0.1 | |

In one embodiment, preferably the sequence identity for the nucleotide sequences is determined using CLUSTAL with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence may be determined over the whole sequence.

In one embodiment the degree of amino acid sequence identity in accordance with the present invention may be suitably determined by means of computer programs known in the art, such as Vector NTI 10 (Invitrogen Corp.). For pairwise alignment the matrix used is preferably BLOSUM62 with Gap opening penalty of 10.0 and Gap extension penalty of 0.1.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids.

Suitably, the degree of identity with regard to an amino acid sequence may be determined over the whole sequence.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other:

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyrlylalanine, thienylalanine, naphthylalanine and phenylglycine.

Replacements may also be made by unnatural amino acids.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

Nucleotide sequences for use in the present invention or encoding a polypeptide having the specific properties defined herein may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences.

The present invention also encompasses the use of nucleotide sequences that are complementary to the sequences discussed herein, or any derivative, fragment or derivative thereof. If the sequence is complementary to a fragment thereof then that sequence can be used as a probe to identify similar coding sequences in other organisms etc.

Polynucleotides which are not 100% homologous to the sequences of the present invention but fall within the scope of the invention can be obtained in a number of ways. Other variants of the sequences described herein may be obtained for example by probing DNA libraries made from a range of individuals, for example individuals from different populations. In addition, other viral/bacterial, or cellular homologues particularly cellular homologues found in mammalian cells (e.g. rat, mouse, bovine and primate cells), may be obtained and such homologues and fragments thereof in general will be capable of selectively hybridising to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction polypeptide recognition sites, or to alter the property or function of the polypeptides encoded by the polynucleotides.

Polynucleotides (nucleotide sequences) of the invention may be used to produce a primer, e.g. a PCR primer, a primer for an alternative amplification reaction, a probe e.g. labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. This will involve making a pair of primers (e.g. of about 15 to 30 nucleotides) flanking a region of the lipid targeting sequence which it is desired to clone, bringing the primers into contact with mRNA or cDNA obtained from an animal or human cell, performing a polymerase chain reaction under conditions which bring about amplification of the desired region, isolating the amplified fragment (e.g. by purifying the reaction mixture on an agarose gel) and recovering the amplified DNA. The primers may be designed to contain suitable restriction enzyme recognition sites so that the amplified DNA can be cloned into a suitable cloning vector.

Hybridisation

The present invention also encompasses the use of sequences that are complementary to the sequences of the present invention or sequences that are capable of hybridising either to the sequences of the present invention or to sequences that are complementary thereto.

The term “hybridisation” as used herein shall include “the process by which a strand of nucleic acid joins with a complementary strand through base pairing” as well as the process of amplification as carried out in polymerase chain reaction (PCR) technologies.

The present invention also encompasses the use of nucleotide sequences that are capable of hybridising to the sequences that are complementary to the subject sequences discussed herein, or any derivative, fragment or derivative thereof.

The present invention also encompasses sequences that are complementary to sequences that are capable of hybridising to the nucleotide sequences discussed herein.

Hybridisation conditions are based on the melting temperature (Tm) of the nucleotide binding complex, as taught in Berger and Kimmel (1987, Guide to Molecular Cloning Techniques, Methods in Enzymology, Vol. 152, Academic Press, San Diego Calif.), and confer a defined “stringency” as explained below.

Maximum stringency typically occurs at about Tm-5° C. (5° C. below the Tm of the probe); high stringency at about 5° C. to 10° C. below Tm; intermediate stringency at about 10° C. to 20° C. below Tm; and low stringency at about 20° C. to 25° C. below Tm. As will be understood by those of skill in the art, a maximum stringency hybridisation can be used to identify or detect identical nucleotide sequences while an intermediate (or low) stringency hybridisation can be used to identify or detect similar or related polynucleotide sequences.

Preferably, the present invention encompasses the use of sequences that are complementary to sequences that are capable of hybridising under high stringency conditions or intermediate stringency conditions to nucleotide sequences encoding polypeptides having the specific properties as defined herein.

More preferably, the present invention encompasses the use of sequences that are complementary to sequences that are capable of hybridising under high stringency conditions (e.g. 65° C. and 0.1×SSC {1×SSC=0.15 M NaCl, 0.015 M Na-citrate pH 7.0}) to nucleotide sequences encoding polypeptides having the specific properties as defined herein.

The present invention also relates to the use of nucleotide sequences that can hybridise to the nucleotide sequences discussed herein (including complementary sequences of those discussed herein).

The present invention also relates to the use of nucleotide sequences that are complementary to sequences that can hybridise to the nucleotide sequences discussed herein (including complementary sequences of those discussed herein).

Also included within the scope of the present invention are the use of polynucleotide sequences that are capable of hybridising to the nucleotide sequences discussed herein under conditions of intermediate to maximal stringency.

In a preferred aspect, the present invention covers the use of nucleotide sequences that can hybridise to the nucleotide sequences discussed herein, or the complement thereof, under stringent conditions (e.g. 50° C. and 0.2×SSC).

In a more preferred aspect, the present invention covers the use of nucleotide sequences that can hybridise to the nucleotide sequences discussed herein, or the complement thereof, under high stringency conditions (e.g. 65° C. and 0.1×SSC).

Expression of Polypeptides

A nucleotide sequence for use in the present invention or for encoding a polypeptide having the specific properties as defined herein can be incorporated into a recombinant replicable vector. The vector may be used to replicate and express the nucleotide sequence, in polypeptide form, in and/or from a compatible host cell. Expression may be controlled using control sequences which include promoters/enhancers and other expression regulation signals. Prokaryotic promoters and promoters functional in eukaryotic cells may be used. Tissue specific or stimuli specific promoters may be used. Chimeric promoters may also be used comprising sequence elements from two or more different promoters described above.

The polypeptide produced by a host recombinant cell by expression of the nucleotide sequence may be secreted or may be contained intracellularly depending on the sequence and/or the vector used. The coding sequences can be designed with signal sequences which direct secretion of the substance coding sequences through a particular prokaryotic or eukaryotic cell membrane.

Constructs

The term “construct”—which is synonymous with terms such as “conjugate”, “cassette” and “hybrid”—includes a nucleotide sequence encoding a polypeptide having the specific properties as defined herein for use according to the present invention directly or indirectly attached to a promoter. An example of an indirect attachment is the provision of a suitable spacer group such as an intron sequence, such as the Sh1-intron or the ADH intron, intermediate the promoter and the nucleotide sequence of the present invention. The same is true for the term “fused” in relation to the present invention which includes direct or indirect attachment. In some cases, the terms do not cover the natural combination of the nucleotide sequence coding for the protein ordinarily associated with the wild type gene promoter and when they are both in their natural environment.

The construct may even contain or express a marker which allows for the selection of the genetic construct.

For some applications, preferably the construct comprises at least a nucleotide sequence of the present invention or a nucleotide sequence encoding a polypeptide having the specific properties as defined herein operably linked to a promoter.

Organism

The term “organism” in relation to the present invention includes any organism that could comprise a nucleotide sequence according to the present invention or a nucleotide sequence encoding for a polypeptide having the specific properties as defined herein and/or products obtained therefrom.

The term “transgenic organism” in relation to the present invention includes any organism that comprises a nucleotide sequence coding for a polypeptide having the specific properties as defined herein and/or the products obtained therefrom, and/or wherein a promoter can allow expression of the nucleotide sequence coding for a polypeptide having the specific properties as defined herein within the organism. Preferably the nucleotide sequence is incorporated in the genome of the organism.

The term “transgenic organism” does not cover native nucleotide coding sequences in their natural environment when they are under the control of their native promoter which is also in its natural environment.

Therefore, the transgenic organism of the present invention includes an organism comprising any one of, or combinations of, a nucleotide sequence coding for a polypeptide having the specific properties as defined herein, constructs as defined herein, vectors as defined herein, plasmids as defined herein, cells as defined herein, or the products thereof. For example the transgenic organism can also comprise a nucleotide sequence coding for a polypeptide having the specific properties as defined herein under the control of a promoter not associated with a sequence encoding a lipid acyltransferase in nature.

Transformation of Host Cells/Organism

The host organism can be a prokaryotic or a eukaryotic organism.

Examples of suitable prokaryotic hosts include bacteria such as E. coli and Bacillus licheniformis, preferably B. licheniformis.

Teachings on the transformation of prokaryotic hosts is well documented in the art, for example see Sambrook at al (Molecular Cloning: A Laboratory Manual, 2nd edition, 1989, Cold Spring Harbor Laboratory Press). If a prokaryotic host is used then the nucleotide sequence may need to be suitably modified before transformation—such as by removal of introns.

In another embodiment the transgenic organism can be a yeast.

Filamentous fungi cells may be transformed using various methods known in the art—such as a process involving protoplast formation and transformation of the protoplasts followed by regeneration of the cell wall in a manner known. The use of Aspergillus as a host microorganism is described in EP 0 238 023.

Another host organism can be a plant. A review of the general techniques used for transforming plants may be found in articles by Potrykus (Annu Rev Plant Physiol Plant Mol Biol [1991] 42:205-225) and Christou (Agro-Food-Industry Hi-Tech March/April 1994 17-27). Further teachings on plant transformation may be found in EP-A-0449375.

General teachings on the transformation of fungi, yeasts and plants are presented in following sections.

Transformed Fungus

A host organism may be a fungus—such as a filamentous fungus. Examples of suitable such hosts include any member belonging to the genera Thermomyces, Acremonium, Aspergillus, Penicillium, Mucor, Neurospora, Trichoderma and the like.

Teachings on transforming filamentous fungi are reviewed in U.S. Pat. No. 5,741,665 which states that standard techniques for transformation of filamentous fungi and culturing the fungi are well known in the art. An extensive review of techniques as applied to N. crassa is found, for example in Davis and de Serres, Methods Enzymol (1971) 17A: 79-143.

Further teachings on transforming filamentous fungi are reviewed in U.S. Pat. No. 5,674,707.

In one aspect, the host organism can be of the genus Aspergillus, such as Aspergillus niger.

A transgenic Aspergillus according to the present invention can also be prepared by following, for example, the teachings of Turner G. 1994 (Vectors for genetic manipulation. In: Martinelli S. D., Kinghorn J. R. (Editors) Aspergillus: 50 years on. Progress in industrial microbiology vol 29. Elsevier Amsterdam 1994. pp. 641-666).

Gene expression in filamentous fungi has been reviewed in Punt et al. (2002) Trends Biotechnol 2002 May; 20(5):200-6, Archer & Peberdy Grit Rev Biotechnol (1997) 17(4):273-306.

Transformed Yeast

In another embodiment, the transgenic organism can be a yeast.

A review of the principles of heterologous gene expression in yeast are provided in, for example, Methods Mol Biol (1995), 49:341-54, and Curr Opin Biotechnol (1997) October; 8(5):554-60

In this regard, yeast—such as the species Saccharomyces cerevisi or Pichia pastoris (see FEMS Microbiol Rev (2000 24(1):45-66), may be used as a vehicle for heterologous gene expression.

A review of the principles of heterologous gene expression in Saccharomyces cerevisiae and secretion of gene products is given by E Hinchcliffe E Kenny (1993, “Yeast as a vehicle for the expression of heterologous genes”, Yeasts, Vol 5, Anthony H Rose and J. Stuart Harrison, eds, 2nd edition, Academic Press Ltd.).

For the transformation of yeast, several transformation protocols have been developed. For example, a transgenic Saccharomyces according to the present invention can be prepared by following the teachings of Hinnen et al., (1978, Proceedings of the National Academy of Sciences of the USA 75, 1929); Beggs, J D (1978, Nature, London, 275, 104); and Ito, H et al (1983, J Bacteriology 153, 163-168).

The transformed yeast cells may be selected using various selective markers—such as auxotrophic markers dominant antibiotic resistance markers.

A suitable yeast host organism can be selected from the biotechnologically relevant yeasts species such as, but not limited to, yeast species selected from Pichia spp., Hansenula spp., Kluyveromyces, Yarrowinia spp., Saccharomyces spp., including S. cerevisiae, or Schizosaccharomyce spp. including Schizosaccharomyce pombe.

A strain of the methylotrophic yeast species Pichia pastoris may be used as the host organism.

In one embodiment, the host organism may be a Hansenula species, such as H. polymorphs (as described in WO01/39544).

Transformed Plants/Plant Cells

A host organism suitable for the present invention may be a plant. A review of the general techniques may be found in articles by Potrykus (Annu Rev Plant Physiol Plant Mol Biol [1991] 42:205-225) and Christou (Agro-Food-Industry Hi-Tech March/April 1994 17-27), or in WO01/16308. The transgenic plant may produce enhanced levels of phytosterol esters and phytostanol esters, for example.

Therefore the present invention also relates to a method for the production of a transgenic plant with enhanced levels of phytosterol esters and phytostanol esters, comprising the steps of transforming a plant cell with a lipid acyltransferase as defined herein (in particular with an expression vector or construct comprising a lipid acyltransferase as defined herein), and growing a plant from the transformed plant cell.

Secretion

Often, it is desirable for the polypeptide to be secreted from the expression host into the culture medium from where the enzyme may be more easily recovered. According to the present invention, the secretion leader sequence may be selected on the basis of the desired expression host. Hybrid signal sequences may also be used with the context of the present invention.

Typical examples of secretion leader sequences not associated with a nucleotide sequence encoding a lipid acyltransferase in nature are those originating from the fungal amyloglucosidase (AG) gene (glaA—both 18 and 24 amino acid versions e.g. from Aspergillus), the a-factor gene (yeasts e.g. Saccharomyces, Kluyveromyces and Hansenula) or the α-amylase gene (Bacillus).

Detection

A variety of protocols for detecting and measuring the expression of the amino acid sequence are known in the art. Examples include enzyme-linked immunosorbent assay (ELISA), radioimmunoassay (RIA) and fluorescent activated cell sorting (FACS).

A wide variety of labels and conjugation techniques are known by those skilled in the art and can be used in various nucleic and amino acid assays.

A number of companies such as Pharmacia Biotech (Piscataway, N.J.), Promega (Madison, Wis.), and US Biochemical Corp (Cleveland, Ohio) supply commercial kits and protocols for these procedures.

Suitable reporter molecules or labels include those radionuclides, enzymes, fluorescent, chemiluminescent, or chromogenic agents as well as substrates, cofactors, inhibitors, magnetic particles and the like. Patents teaching the use of such labels include U.S. Pat. No. 3,817,837; U.S. Pat. No. 3,850,752; U.S. Pat. No. 3,939,350; U.S. Pat. No. 3,996,345; U.S. Pat. No. 4,277,437; U.S. Pat. No. 4,275,149 and U.S. Pat. No. 4,366,241.

Also, recombinant immunoglobulins may be produced as shown in U.S. Pat. No. 4,816,567.

Fusion Proteins

An enzyme for use in the present invention may be produced as a fusion protein, for example to aid in extraction and purification thereof. Examples of fusion protein partners include glutathione-S-transferase (GST), 6×His, GAL4 (DNA binding and/or transcriptional activation domains) and β-galactosidase. It may also be convenient to include a proteolytic cleavage site between the fusion protein partner and the protein sequence of interest to allow removal of fusion protein sequences. Preferably the fusion protein will not hinder the activity of the protein sequence.

Gene fusion expression systems in E. coli have been reviewed in Curr. Opin. Biotechnol. (1995) 6(5):501-6.

The amino acid sequence of a polypeptide having the specific properties as defined herein may be ligated to a non-native sequence to encode a fusion protein. For example, for screening of peptide libraries for agents capable of affecting the substance activity, it may be useful to encode a chimeric substance expressing a non-native epitope that is recognised by a commercially available antibody.

Additional POIs

The sequences for use according to the present invention may also be used in conjunction with one or more additional proteins of interest (POIs) or nucleotide sequences of interest (NOIs).

Non-limiting examples of POIs include: proteins or enzymes involved in starch metabolism, proteins or enzymes involved in glycogen metabolism, acetyl esterases, aminopeptidases, amylases, arabinases, arabinofuranosidases, carboxypeptidases, catalases, cellulases, chitinases, chymosin, cutinase, deoxyribonucleases, epimerases, esterases, α-galactosidases, β-galactosidases, α-glucanases, glucan lysases, endo-β-glucanases, glucoamylases, glucose oxidases, α-glucosidases, β-glucosidases, glucuronidases, hemicellulases, hexose oxidases, hydrolases, invertases, isomerases, laccases, lipases, lyases, mannosidases, oxidases, oxidoreductases, pectate lyases, pectin acetyl esterases, pectin depolymerases, pectin methyl esterases, pectinolytic enzymes, peroxidases, phenoloxidases, phytases, polygalacturonases, proteases, rhamno-galacturonases, ribonucleases, thaumatin, transferases, transport proteins, transglutaminases, xylanases, hexose oxidase (D-hexose: O₂-oxidoreductase, EC 1.1.3.5) or combinations thereof. The NOI may even be an antisense sequence for any of those sequences.

The POI may even be a fusion protein, for example to aid in extraction and purification.

The POI may even be fused to a secretion sequence.

Other sequences can also facilitate secretion or increase the yield of secreted POI. Such sequences could code for chaperone proteins as for example the product of Aspergillus niger cyp B gene described in UK patent application 9821198.0.

The NOI may be engineered in order to alter their activity for a number of reasons, including but not limited to, alterations which modify the processing and/or expression of the expression product thereof. By way of further example, the NOI may also be modified to optimise expression in a particular host cell. Other sequence changes may be desired in order to introduce restriction enzyme recognition sites.

The NOI may include within it synthetic or modified nucleotides—such as methylphosphonate and phosphorothioate backbones.

The NOI may be modified to increase intracellular stability and half-life. Possible modifications include, but are not limited to, the addition of flanking sequences of the 5′ and/or 3′ ends of the molecule or the use of phosphorothioate or 2′ O-methyl rather than phosphodiesterase linkages within the backbone of the molecule.

Food

The composition of the present invention may be used as—or in the preparation of—a food. Here, the term “food” is used in a broad sense—and covers food for humans as well as food for animals (i.e. a feed). In a preferred aspect, the food is for human consumption.

The food may be in the form of a solution or as a solid—depending on the use and/or the mode of application and/or the mode of administration.

When used as—or in the preparation of—a food—such as functional food—the composition of the present invention may be used in conjunction with one or more of: a nutritionally acceptable carrier, a nutritionally acceptable diluent, a nutritionally acceptable excipient, a nutritionally acceptable adjuvant, a nutritionally active ingredient.

Food Ingredient

The composition of the present invention may be used as a food ingredient.

As used herein the term “food ingredient” includes a formulation which is or can be added to functional foods or foodstuffs as a nutritional supplement and/or fiber supplement. The term food ingredient as used here also refers to formulations which can be used at low levels in a wide variety of products that require gelling, texturising, stabilising, suspending, film-forming and structuring, retention of juiciness and improved mouthfeel, without adding viscosity.

The food ingredient may be in the from of a solution or as a solid—depending on the use and/or the mode of application and/or the mode of administration.

The invention will now be described, by way of example only, with reference to the following Figures and Examples.

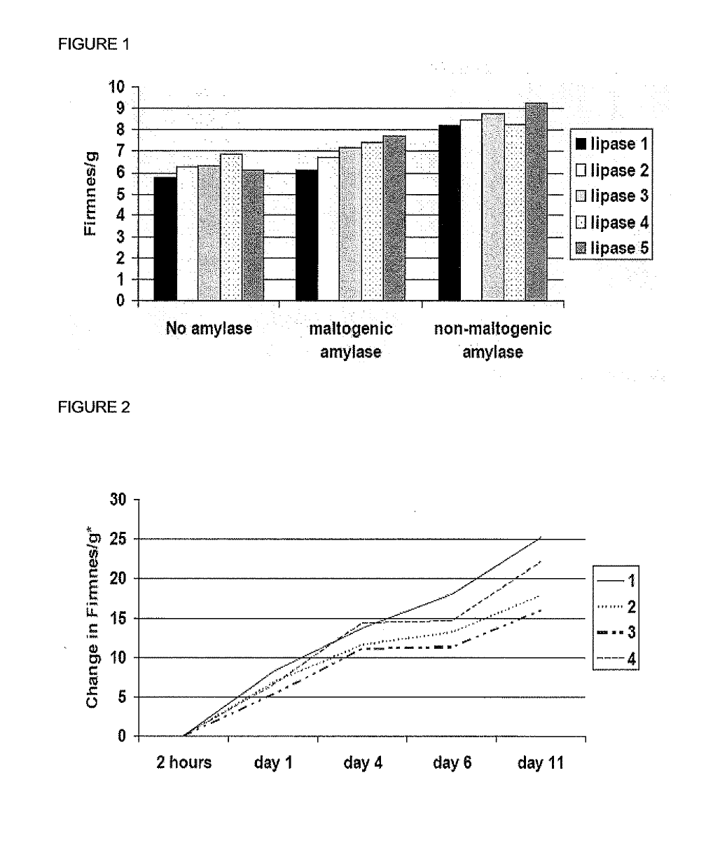

FIG. 1 shows the initial firmness after two hours post baking for 1: Lipopan F, 2: GRINDAMYL POWERBAKE 4070,: Lipase 3 (SEQ ID No. 3), 4: Exel 16 and 5: YieldMax. The maltogenic amylase used is Novamyl™and the non-maltogenic amylase is G4 (SEQ ID No. 1);

FIG. 2 shows the change in firmness from two hours post-baking for a bread made using 1: no enzyme, 2: a non-maltogenic amylase G4 (SEQ ID No. 1); 3: a non-maltogenic amylase G4 (SEQ ID No. 1) and a lipolytic enzyme (SEQ ID No. 9) and 4: a lipolytic enzyme (SEQ ID No. 9);

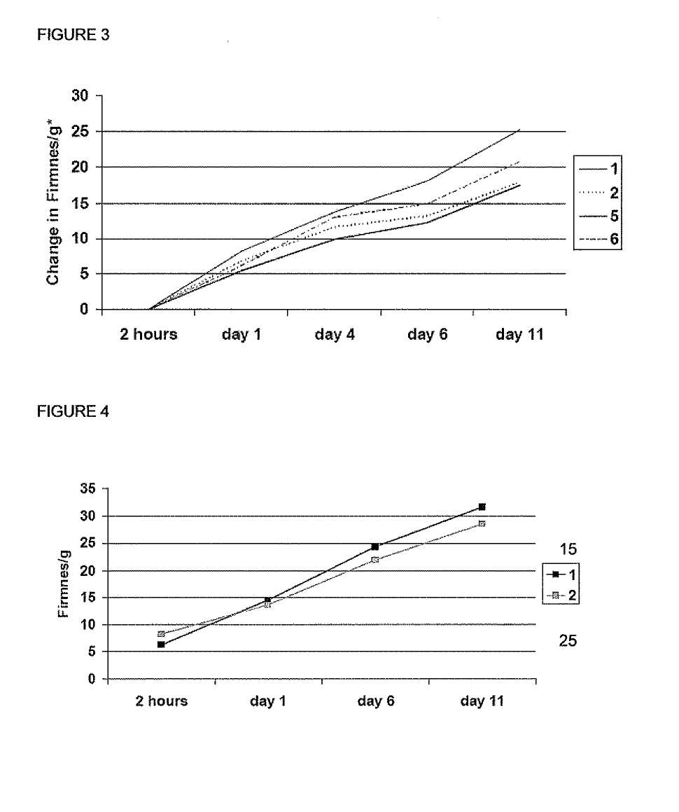

FIG. 3 shows the change in firmness from two hours post-baking for a bread made using 1: no enzyme, 5: a non-maltogenic amylase G4 (SEQ ID No. 1) and a lipolytic enzyme (SEQ ID No. 9) and a lipolytic enzyme (Grindamyl EXEL 16), and 6: a lipolytic enzyme (Grindamyl EXEL 16);

FIG. 4 shows the change in firmness from two hours post-baking for a bread made using 1: no enzyme and 2: Lipopan F;

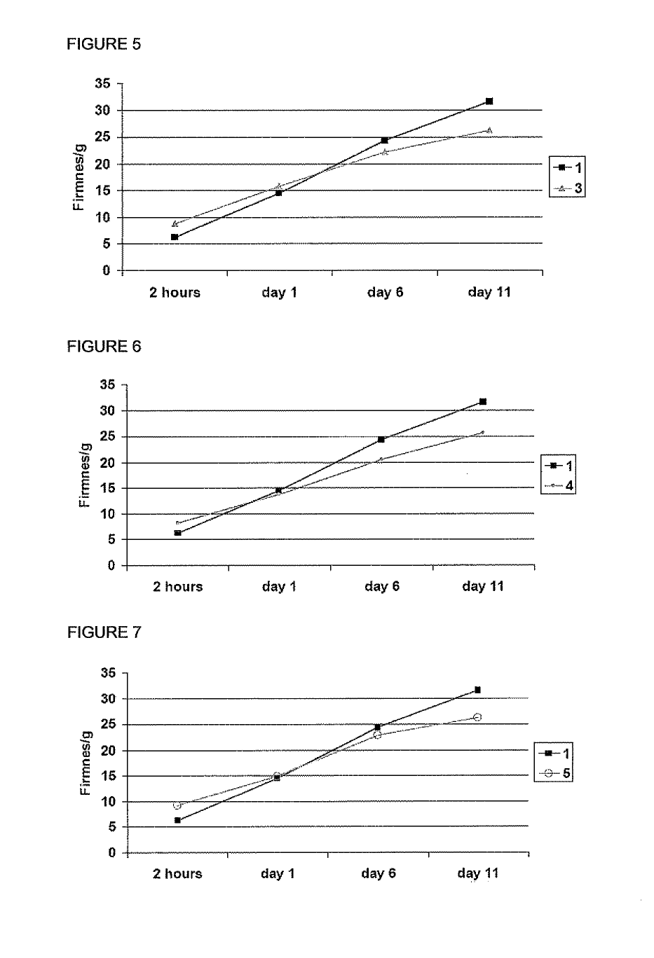

FIG. 5 shows the change in firmness from two hours post-baking for a bread made using 1: no enzyme and 3: Lipase 3 (SEQ ID No. 3);

FIG. 6 shows the change in firmness from two hours post-baking for a bread made using 1: no enzyme and 4: Grindamyl EXEL 16;

FIG. 7 shows the change in firmness from two hours post-baking for a bread made using 1: no enzyme and 5: Yieldmax;

FIG. 8 shows the amino acid sequence for a non-maltogenic amylase for use in the present invention SEQ ID No. 1;

FIG. 9a shows the amino acid sequence for a lipolytic enzyme for use in the present invention SEQ ID No. 2;

FIG. 9b shows the amino acid sequence for a lipolytic enzyme for use in the present invention GRINDAMYL POWERbake 4070—SEQ ID No. 9;

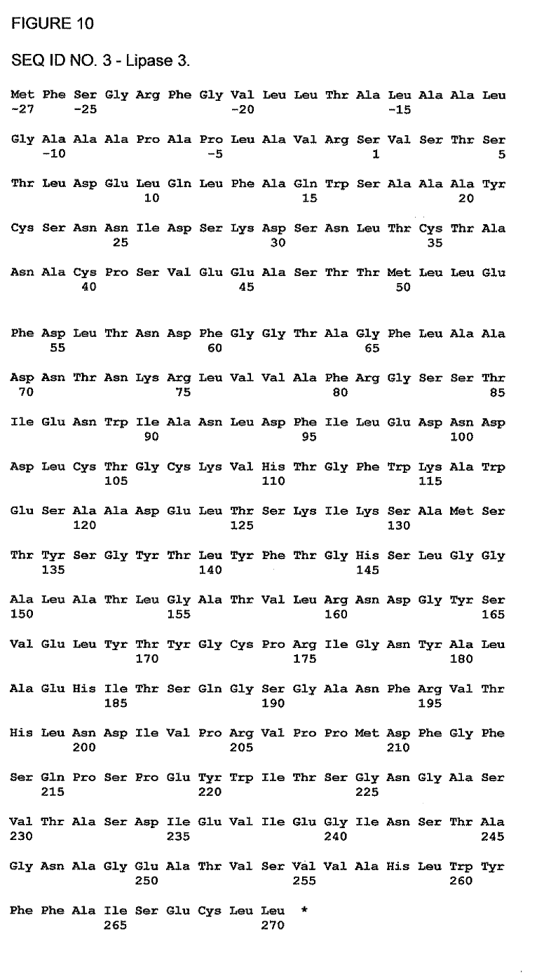

FIG. 10 shows the amino acid sequence for a lipolytic enzyme for use in the present invention Lipase 3 SEQ ID No. 3.

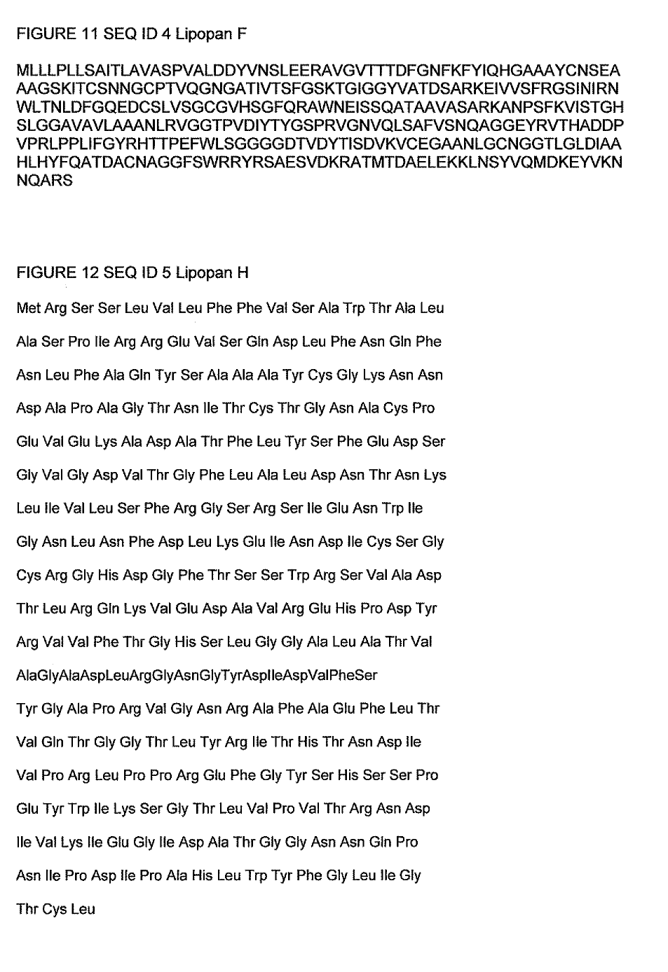

FIG. 11 shows SEQ ID NO. 4 Lipopan F (also described in SEQ ID 2 of WO 98/26057). WO 98/26057 is incorporated herein by reference.

FIG. 12 shows SEQ ID NO 5 Lipopan H (also describe in SEQ ID 2 of U.S. Pat. No. 5,869,438). U.S. Pat. No. 5,869,438 is incorporated herein by reference.

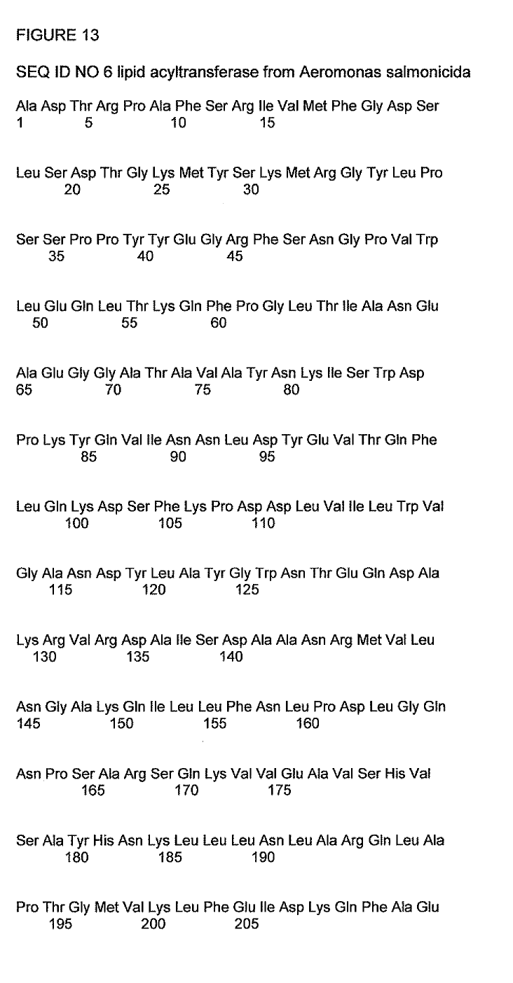

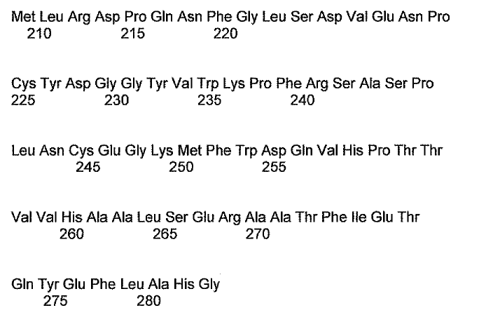

FIG. 13 shows SEQ ID NO 6 the amino acid sequence of a variant lipid acyltransferase from Aeromonas salmonicida (Also described as SEQ ID 90 from WO09/024736). WO09/024736 is incorporated herein by reference.

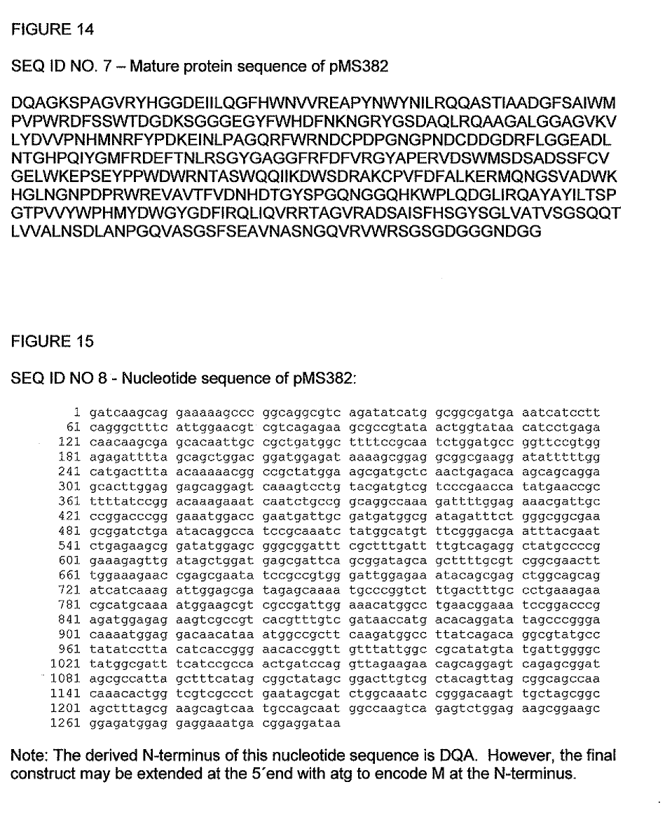

FIG. 14 shows SEQ ID 7 the mature protein sequence of pMS382 (also described as SEQ ID NO 1 of application EP 09160655.8). EP 09160655.8 is incorporated herein by reference.

FIG. 15 shows SEQ ID 8 the Nucleotide sequence of pMS382 (also described as SEQ ID No. 52, of application EP 09160655.8).

### EXAMPLE 1

### Baking Experiments

Ingredients

Reform DK2007-00113 standard Danish wheat flour named Reform flour.

Dry yeast 1.5%

Salt 1.5%

Granulated Sugar 250-400 1.5%

Shortening 1.0%

Water 59%

Calcium propionate 0.3%

Ascorbic acid 10 ppm.

Standard Toast Bread

Softness Procedure

Recipe:

| Ingredients | % | g |
|---|---|---|
| Wheat flour | 100 | 2000 |
| Dry yeast | 1.5 | 30 |
| Salt | 1.5 | 30 |
| Sugar | 1.5 | 30 |
| VEGAO 73-02 NT (AU) | 1 | 20 |
| (shortening) | | |
| Water | 59% | |
| *Calcium propionate | 0.3 | 6 |

Optimised with Alpha Amylase Blend and Ascorbic acid.
*Calcium propionate is used if softness measurements are required after more than 7 days.

Enzymes

GRINDAMYL™ A1000—80 ppm of formulated product was used in all experiments, corresponding to an enzyme concentration in the dough of approximately 4.1 mg/kg (4.1 ppm enzyme in the dough).

GRINDAMYL™ H 121—150 ppm of formulated xylanase product was used in all experiments, corresponding to 0.15 g formulated H121/kg. This is a dosage of 0.20 mg xylanase protein/kg flour (0.2 ppm enzyme in the dough).

Novamyl 1500™—300 ppm of formulated product was used in the experiments, corresponding to an enzyme concentration in the dough of approximately 1.5 mg/kg (1.5 ppm enzyme in the dough).

GRINDAMYL™ MAX-LIFE U4—was used at a dosage of 50 ppm as a further enzyme in some of the trials. This is an example of an anti-staling enzyme.

GRINDAMYL™ EXEL 16—250 ppm of formulated product was used in some trials. Dosage was 1.03 mg/kg flour (1 ppm enzyme in the dough).

YieldMax™ (No. 3461)—860 ppm of formulated product was used in some trials. Dosage was 2-5 ppm enzyme protein in dough.

Lipopan F (SEQ ID No 4)—was used in some trials at a dosage of 100 ppm of formulated product.

Lipase 3 (SEQ ID No. 3) was used in some trials at a dosage of 100 ppm of formulated product.

EDS 218 was used in some trials at a dosage of 163 ppm of formulated product and about 1 ppm of enzyme protein in dough.

GRINDAMYL Captive POWERfresh was used in some trials at a dosage of 600 ppm of formulated product.

Variant lipid acyltransferase from Aeromonas salmonicida as shown in SEQ ID NO 6.

Each of the above enzymes may be used at about 10 ppm in the dough.

Methodology

1) Mix all the ingredients and the appropriate enzymes for 1 minute slowly using a DIOSNA mixer SP 12-4/FU—add water

2) Mix for 2 minutes low speed—5.5 minutes high speed (“DK toast” prog.)

3) Dough temperature must be approximately 24-25° C.

4) Rest dough for 10 minutes in cabinet at 30° C.

5) Scale 4 dough pieces at 750 g

6) Rest dough pieces for 5 minutes at ambient

7) Mould on Glimek baking system roller BM1; 1:4-2:4-3:14-4:12—width: 10 outside

8) Put dough pieces in DK toast tins—3 are sealed with lid—leave 1 open for volume measurement

9) Proofing: 60 minutes at 33° C., 85% Relative Humidity—when using calcium propionate or 50 minutes at 33° C., 85% Relative Humidity—without use of calcium propionate

10) Bake for 30 minutes at 220° C. with 12 sec. steam-open damper after 20 minutes (Miwe prog. 2)

11) After baking take breads out of the tins

12) Cool breads for 70 minutes at ambient before weighing and measuring of volume

Firmness may be measured after 2 hours, 1 day, 6 days and 11 days after baking using Texture Profile Analysis of Bread described below.

Texture Profile Analysis of Bread

The Firmness, cohesiveness and resilience of bread may be determined by analysing bread slices by Texture Profile Analysis using a Texture Analyser from Stable Micro Systems, UK. The probe used was aluminium and had a diameter of 50 mm.

Bread was sliced into 12.5 mm thick slices. The slices were stamped out into circular pieces with a diameter of 45 mm and measured individually. The weight of the each individual piece may optionally also be measured for determination of firmness/gram of breadcrumb.

The following settings were used:

Pre Test Speed: 2 mm/s

Test Speed: 2 mm/s

Post Test Speed: 10 mm/s

Rupture Test Distance: 1%

Distance: 40%

Force: 0.098 N

Time: 5.00 sec

Count: 5

Load Cell: 5 kg

Trigger Type: Auto—0.01 N

The amount of pressure (Hectopascals, HPa) required to compress the bread slice by 40% is calculated as the force (Newtons, N) divided by the diameter of the probe (millimetres, mm).

The firmness (Hectopascals/gram, HPa/g) of the bread is determined by dividing the pressure required to compress the bread slice by 40% by the number of grams of bread.

Results

FIG. 1 shows the results after two hours baking. As can be seen, the use of a lipolytic enzyme in combination with an amylase (particularly a non-maltogenic amylase) increased the initial firmness of the bread.

FIGS. 2 and 3 show the increase in firmness from the initial firmness (i.e. the increase in firmness after 2 hours post-baking.

As can be seen, the combination of an amylase (a non-maltogenic amylase as set forth in SEQ ID No. 1) and a lipolytic enzyme reduced the increase in firmness over time when compared to a control enzyme where this amylase and/or a lipolytic enzyme was not added.

FIGS. 4 to 7 show the both the increase in initial firmness and decrease in firmness thereafter (i.e. an improvement in bread stackability) associated with the use of an amylase (a non-maltogenic amylase as set forth in SEQ ID No, 1) in combination with a lipolytic enzyme (Lipopan F, Lipase 3 (SEQ ID No. 3), Grindamyl EXEL 16, and Yieldmax, respectively).

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

1. Use of an amylase and a lipolytic enzyme for improving the stackability of bread.

2. Use according to claim 1, wherein the amylase is a non-maltogenic amylase.

3. Use according to claim 1 wherein the amylase comprises:
a) an amino acid sequence as set forth in SEQ ID No. 1; or
b) an amino acid sequence having at least 75% identity to SEQ ID No. 1 and encoding a non-maltogenic amylase.

4. Use according to claim 1, wherein the lipolytic enzyme has one or more of the following activities selected from the group consisting of: phospholipases activity, glycolipase activity, triacylglycerol hydrolysing activity, lipid acyltransferase activity, and any combination thereof

5. Use according to claim 1, wherein the lipolytic enzyme comprises one or more of the following amino acid sequences:
a) an amino acid sequence as set forth in SEQ ID No. 2 or 9;
b) an amino acid sequence as set forth in SEQ ID no. 3;
c) an amino acid sequence as set forth in SEQ ID No. 4;
d) an amino acid sequence as set forth in SEQ ID No. 5; or
e) an amino acid sequence encoding a lipolytic enzyme having at least 70% identity to any of the sequences in a) to d).

6. Use according to claim 1, wherein an additional enzyme is present, such as a xylanase and/or an antistaling amylase.

7. A method of preparing a dough comprising:
a) adding an amylase as set forth in SEQ ID No. 1 or a non-maltogenic amylase having at least 75% identity to SEQ ID No. 1 in an amount of up to 10 ppm dough; and
b) adding a lipolytic enzyme in an amount of up to 10 ppm dough.

8. A method according to claim 7, wherein the amount of lipolytic enzyme used is 0.2-2 ppm dough.

9. A dough comprising:
a) an amylase as set forth in SEQ ID No. 1 or a non-maltogenic amylase having at least 75% identity to SEQ ID No. 1; and
b) a lipolytic enzyme,
wherein the amount of amylase and lipolytic enzyme are each up to 10 ppm dough.

10. A baked product prepared by baking the dough of claim 9.

11. A bread having:
a) an initial firmness of at least 7 HPa/g;
b) a change in firmness from 2 hours post baking of:
i. less than or equal to 12 HPa/g after 4 days; and/or
ii. less than or equal to 15 HPa/g after 6 days; and/or
iii. less than or equal to 20 HPa/g after 11 days.

12. A bread having:
a) an initial firmness of at least 7 HPa/g;
b) a change in firmness from 2 hours post baking of:
i. less than or equal 1.7 times the initial firmness after 4 days; and/or
ii. less than or equal to 2.1 times the initial firmness after 6 days; and/or
iii. less than or equal to 2.9 times the initial firmness after 11 days.

13.-17. (canceled)


SEQUENCE LISTING (9 sequences)

SEQ ID NO: 1 - protein, 430 aa, Artificial Sequence
  Non-maltogenic amylase
MDQAGKSPAGVRYHGGDEIILQGFHWNVVREAPYNWYNILRQQASTIAADGFSAIWMPVPWRDFSSWTDGDKSGGGEGYFWHDFNKNGRYGSDAQLRQAAGALGGAGVKVLYDVVPNHMNRFYPDKEINLPAGQRFWRNDCPDPGNGPNDCDDGDRFLGGEADLNTGHPQIYGMFRDEFTNLRSGYGAGGFRFDFVRGYAPERVDSWMSDSADSSFCVGELWKEPSEYPPWDWRNTASWQQIIKDWSDRAKCPVFDFALKERMQNGSVADWKHGLNGNPDPRWREVAVTFVDNHDTGYSPGQNGGQHKWPLQDGLIRQAYAYILTSPGTPVVYWPHMYDWGYGDFIRQLIQVRRTAGVRADSAISFHSGYSGLVATVSGSQQTLVVALNSDLANPGQVASGSFSEAVNASNGQVRVWRSGSGDGGGNDGG

SEQ ID NO: 2 - protein, 275 aa, Artificial Sequence
  Lipolytic enzyme
AVGVTSTDFTNFKFYIQHGAAAYCNSGTAAGAKITCSNNGCPTIESNGVTVVASFTGSKTGIGGYVSTDSSRKEIVVAIRGSSNIRNWLTNLDFDQSDCSLVSGCGVHSGFQNAWAEISAQASAAVAKARKANPSFKVVATGHSIGGAVATLSAANLRAAGTPVDIYTYGAPRVGNAALSAFISNQAGGEFRVTHDKDPVPRIPPLIFGYRHTTPEYWISGGGGDKVDYAISDVKVCEGAANLMCNGGTLGIDIDAHIHYFQATDACNAGGFSWR

SEQ ID NO: 3 - protein, 297 aa, Artificial Sequence
  Lipase 3
MFSGRFGVLLTALAALGAAAPAPLAVRSVSTSTLDELQLFAQWSAAAYCSNNIDSKDSNLTCTANACPSVEEASTTMLLEFDLTNDFGGTAGFLAADNTNKRLVVAFRGSSTIENWIANLDFILEDNDDLCTGCKVHTGFWKAWESAADELTSKIKSAMSTYSGYTLYFTGHSLGGALATLGATVLRNDGYSVELYTYGCPRIGNYALAEHITSQGSGANFRVTHLNDIVPRVPPMDFGFSQPSPEYWITSGNGASVTASDIEVIEGINSTAGNAGEATVSVVAHLWYFFAISECLL

SEQ ID NO: 4 - protein, 345 aa, Artificial Sequence
  Lipopan F
MLLLPLLSAITLAVASPVALDDYVNSLEERAVGVTTTDFGNFKFYIQHGAAAYCNSEAAAGSKITCSNNGCPTVQGNGATIVTSFGSKTGIGGYVATDSARKEIVVSFRGSINIRNWLTNLDFGQEDCSLVSGCGVHSGFQRAWNEISSQATAAVASARKANPSFKVISTGHSLGGAVAVLAAANLRVGGTPVDIYTYGSPRVGNVQLSAFVSNQAGGEYRVTHADDPVPRLPPLIFGYRHTTPEFWLSGGGGDTVDYTISDVKVCEGAANLGCNGGTLGLDIAAHLHYFQATDACNAGGFSWRRYRSAESVDKRATMTDAELEKKLNSYVQMDKEYVKNNQARS

SEQ ID NO: 5 - protein, 291 aa, Artificial Sequence
  Lipopan H
MRSSLVLFFVSAWTALASPIRREVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVTRNDIVKIEGIDATGGNNQPNIPDIPAHLWYFGLIGTCL

SEQ ID NO: 6 - protein, 280 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFRSASPLNCEGKMFWDQVHPTTVVHAALSERAATFIETQYEFLAHG

SEQ ID NO: 7 - protein, 429 aa, Artificial Sequence
  Mature protein sequence of pMS382
DQAGKSPAGVRYHGGDEIILQGFHWNVVREAPYNWYNILRQQASTIAADGFSAIWMPVPWRDFSSWTDGDKSGGGEGYFWHDFNKNGRYGSDAQLRQAAGALGGAGVKVLYDVVPNHMNRFYPDKEINLPAGQRFWRNDCPDPGNGPNDCDDGDRFLGGEADLNTGHPQIYGMFRDEFTNLRSGYGAGGFRFDFVRGYAPERVDSWMSDSADSSFCVGELWKEPSEYPPWDWRNTASWQQIIKDWSDRAKCPVFDFALKERMQNGSVADWKHGLNGNPDPRWREVAVTFVDNHDTGYSPGQNGGQHKWPLQDGLIRQAYAYILTSPGTPVVYWPHMYDWGYGDFIRQLIQVRRTAGVRADSAISFHSGYSGLVATVSGSQQTLVVALNSDLANPGQVASGSFSEAVNASNGQVRVWRSGSGDGGGNDGG

SEQ ID NO: 8 - DNA, 1290 bp, Artificial Sequence
  Nucleotide sequence of pMS382
gatcaagcaggaaaaagcccggcaggcgtcagatatcatggcggcgatgaaatcatccttcagggctttcattggaacgtcgtcagagaagcgccgtataactggtataacatcctgagacaacaagcgagcacaattgccgctgatggcttttccgcaatctggatgccggttccgtggagagattttagcagctggacggatggagataaaagcggaggcggcgaaggatatttttggcatgactttaacaaaaacggccgctatggaagcgatgctcaactgagacaagcagcaggagcacttggaggagcaggagtcaaagtcctgtacgatgtcgtcccgaaccatatgaaccgcttttatccggacaaagaaatcaatctgccggcaggccaaagattttggagaaacgattgcccggacccgggaaatggaccgaatgattgcgatgatggcgatagatttctgggcggcgaagcggatctgaatacaggccatccgcaaatctatggcatgtttcgggacgaatttacgaatctgagaagcggatatggagcgggcggatttcgctttgattttgtcagaggctatgccccggaaagagttgatagctggatgagcgattcagcggatagcagcttttgcgtcggcgaactttggaaagaaccgagcgaatatccgccgtgggattggagaaatacagcgagctggcagcagatcatcaaagattggagcgatagagcaaaatgcccggtctttgactttgccctgaaagaacgcatgcaaaatggaagcgtcgccgattggaaacatggcctgaacggaaatccggacccgagatggagagaagtcgccgtcacgtttgtcgataaccatgacacaggatatagcccgggacaaaatggaggacaacataaatggccgcttcaagatggccttatcagacaggcgtatgcctatatccttacatcaccgggaacaccggttgtttattggccgcatatgtatgattggggctatggcgatttcatccgccaactgatccaggttagaagaacagcaggagtcagagcggatagcgccattagctttcatagcggctatagcggacttgtcgctacagttagcggcagccaacaaacactggtcgtcgccctgaatagcgatctggcaaatccgggacaagttgctagcggcagctttagcgaagcagtcaatgccagcaatggccaagtcagagtctggagaagcggaagcggagatggaggaggaaatgacggaggataa

SEQ ID NO: 9 - protein, 275 aa, Artificial Sequence
  Lipolytic enzyme
AVGVTSTDFTNFKFYIQHGAAAYCNSGTAAGAKITCSNNGCPTIESNGVTVVASFTGSKTGIGGYVSTDSSRKEIVVAIRGSSNIRNWLTNLDFDQSDCSLVSGCGVHSGFQNAWAEISAQASAAVAKARKANPSFKVVATGHSIGGAVATLSAANLRAAGTPVDIYTYGAPRVGNAALSAFISNQAGGEFRVTHDKDPVPRIPPLIFGYRHTTPEYWLSGGGGDKVDYAISDVKVCEGAANLMCNGGTLGIDIDAHIHYFQATDACNAGGFSWR